(19) United States
(12) Patent Application Publication
(10) Pub. No.: US 2008/0041807 A1
(43) Pub. Date: Feb. 21, 2008

(54) Disposable nursing bottle

(76) Inventor: Mirei Tominaga, Osaka (JP)

Correspondence Address: HARNESS, DICKEY & PIERCE, P.L.C., P.O. BOX 8910, RESTON, VA, 20195, US

(21) Appl. No.: 11/506,883

(22) Filed: Aug. 21, 2006

(51) Int. Cl. A61J 9/00

(52) U.S. Cl. 215/11.3

(57) ABSTRACT

A liquid carrying liner which is directly contacted and wetted with a liquid, and a nipple are made disposable. In a liner holder formed of a hard synthetic resin into a cylindrical shape of a predetermined length, there is so inserted and set a liquid carrying liner, which is formed of a thin and soft synthetic resin into a tube shape longer than the liner holder and which is integrated at its upper end portion with a root portion of a nipple, as is positioned and retained without any play. The liner is folded at its folding skirt hanging out by a predetermined length from a lower end portion of the holder, so that the liner is clamped and fixed in a sealed state between the holder and a bottom cap made of a hard synthetic resin and removably fitted on the holder.

### BACKGROUND OF THE INVENTION

1. Field of the Invention

The present invention relates to a nursing bottle having a disposable liquid carrying liner and a disposable nipple.

2. Description of the Related Art

A nursing bottle, in which a liner for carrying a liquid such as milk is used as a so-called “cartridge” and then replaced by a new one, is described in Japanese Unexamined Patent Publication JP-A 8-187273 (1996), Japanese Unexamined Patent Publication JP-A 10-155878 (1998), and Japanese Unexamined Patent Publication JP-A 11-146903 (1999).

In these liner disposable type nursing bottles, moreover, the liquid does not contact with the holder itself of the liner so that the holder need not be washed or sterilized. As a result, the nursing bottles can be repeatedly used and conveniently carried out on vehicles or for travels.

In the invention of JP-A 11-146903 (1999), for example, a disposable liner (18) and a nipple (or a nipple portion) (20) are made independent of each other, and the nipple (20) is reused. However, the liquid never fails to contact with and wet the nipple (20). Therefore, the nursing bottle cannot be repeatedly used without washing and/or sterilizing the nipple (20). As a result, the aforementioned conveniences are inhibited.

In a case where the nipple (20) left after the disposal of the liner (18) is repeatedly used, it is difficult for mother of an infant to discriminate with her eyes the sanitary degree of the nipple (20) on whether the nipple (20) is new or old. In this sense, the nursing bottle of the related art is still inconvenient.

Moreover, the liner (18) and the nipple (20), as made separate, are threadably fastened on the open edge portion of a holder (12) by a ring-shaped holding collar (22). In the case of an incompletely fastened state, however, the liquid may leak out. In cases such that the nipple (20) is erroneously grasped at its root portion or that an infant may bite and pull out the nipple (20), the nipple (20) may come out of the collar (22).

### SUMMARY OF THE INVENTION

An object of the invention is to solve the problems thus far described. In order to accomplish the object, the invention provides a disposable nursing bottle comprising:

a liner holder formed into a cylindrical shape, having openings at upper and lower ends thereof, the liner holder being made hard and an inside thereof being visible;

a liquid carrying liner formed into a tube longer and thinner than the holder, the liquid carrying liner being removably inserted into the holder;

a nipple integrally connected to the liner;

a nipple protecting top hood removably covering the opening at the upper end of the holder; and

a bottom cap removably covering the opening at the lower end of the holder,

wherein desired liquid is poured from the opening at the lower end of the liquid carrying liner in a state where the top hood is put downward so that the opening at the lower end of the liquid carrying liner is directed upward, and a protruded portion of the liquid carrying liner which protrudes from the liner holder is folded and then the bottom cap is pressed and fitted on the folded protruded portion to seal the opening so that the liquid to be contained is encapsulated in the liner.

In the invention, it is preferable that the nipple is formed integrally with the liquid carrying liner by use of silicone rubber as a common material.

In the invention, it is preferable that the liner holder is formed of a light transmitting synthetic resin.

In the invention, it is preferable that the line holder is formed of a metal, and over a substantially entire length of the liner holder is provided a slit through which an inside of the liquid carrying liner is visible.

In the invention, it is preferable that the protruded portion of the liquid carrying liner hanging out by a predetermined length from a lower end portion of the holder is divided into a shorter skirt member on an entrance corner side and a longer skirt member on an exit corner side by a slit which has a predetermined depth not reaching the lower end portion of the holder cut off upward and an appropriate opening width.

In the invention, it is preferable that a radially large bead or flange for positioning bulges out from a root portion of the nipple, and

the bead or flange is placed and retained on an upper end portion of the holder, or fitted and retained in a nipple receiving groove which is formed in an upper end portion of an inner circumference in the holder so as to be complementary to the bead or flange.

In the invention, it is preferable that a radially large bead or flange for positioning, which bulges out integrally from a root portion of the nipple is placed and retained on an upper end portion of the holder,

a radially large threaded mouth cylinder of an appropriately lower half portion in a nipple holding collar formed of a hard synthetic resin into a stepped cylinder is removably fastened threadably on an outer circumference of the holder so that the bead or flange of the nipple is pushed and fixed downward, and

the nipple protecting top hood is removably fitted over a radially smaller top hood receiving cylinder of an appropriately upper half portion in the nipple holding collar.

In the invention, it is preferable that the liner holder is formed of a metal wire and provided with a pulling hook for biasing the bottom cap toward the liner holder by use of spring force in a state where the bottom cap is fitted on the liner holder by way of the liquid carrying liner.

Further, in the invention, it is preferable that the nipple is provided with a liquid sucking hole to which a peeling seal is adhered.

According to the invention, the nipple and the liner which come into direct contact with the liquid are formed into the so-called cartridge, in which they are continuously integrated in advance, so that the liner with the nipple can be extracted from the holder and discarded altogether. Thus, the constitution can solve the problem of the related art drastically as the disposable nursing bottle with remarkable conveniences on vehicles or for travels.

When the nursing bottle is used, the root portion of the nipple is in the inserted set state where the root portion is stably positioned and retained in the holder. The lower end portion of the liner continuously integrated with that nipple is folded as the folding skirt across the lower end portion of the holder and is clamped and fixed in a sealed state between the holder and the bottom cap owing to clamping of the bottom cap to the holder. As a result, the liquid will not accidentally leak even when the nursing bottle is turned to the upright state or felled down sideways, so that the nursing bottle can be used without any trouble like before.

According to the invention, the divided longer and shorter skirt members can prevent the fear which might otherwise be caused by the fact that the overlapped portion of the folded skirt of the liner is excessively thickened or wrinkled to degrade the contact of the bottom cap with the holder or to invite the leakage of the liquid, thereby to keep the appearance satisfactory.

According to the invention, the root portion of the nipple can be stably and firmly connected to the liner as the radially large bead or flange, and can also be smoothly inserted and set downward in the holder thereby to improve the workability.

According to the invention, moreover, the nipple belonging to the liner can be so held and fixed in the holder as may not accidentally float or come out, so that the nursing bottle can be safely used for the nursing.

### BRIEF DESCRIPTION OF THE DRAWINGS

Other and further objects, features, and advantages of the invention will be more explicit from the following detailed description taken with reference to the drawings wherein:

FIG. 1 is a front elevation showing a disposable nursing bottle according to a first embodiment of the invention;

FIG. 2 is a front elevation showing the disassembled state of FIG. 1;

FIG. 3 is a section taken along line III-III of FIG. 2;

FIG. 4 is a section taken along line IV-IV of FIG. 3;

FIG. 5 is a perspective view showing an extracted liquid carrying liner;

FIG. 6 is a sectional view showing the set state, in which the liner is inserted into a holder;

FIG. 7 is a sectional view showing the state, in which the skirt of the liner is folded from the state of FIG. 6;

FIG. 8 is a sectional view showing the covered state, in which a bottom cap is fitted from the state of FIG. 7;

FIG. 9 is a sectional view showing the using state of the disposable nursing bottle;

FIG. 10 is a front elevation showing a disposable nursing bottle according to a second embodiment of the invention;

FIG. 11 is a section taken along line XI-XI of FIG. 10;

FIG. 12 is a sectional view showing a disposable nursing bottle according to a third embodiment of the invention;

FIG. 13 is a sectional view showing the using state of FIG. 12, from which a top hood is removed

FIG. 14 is a sectional view showing a disposable nursing bottle according to a fourth embodiment of the invention; and

FIG. 15 is a perspective view of a metallic pulling hook.

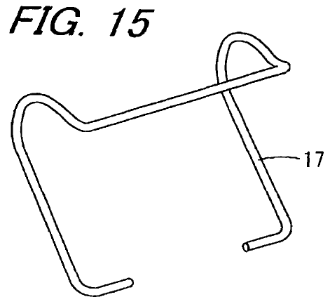

### DETAILED DESCRIPTION

Now referring to the drawings, preferred embodiments of the invention are described below.

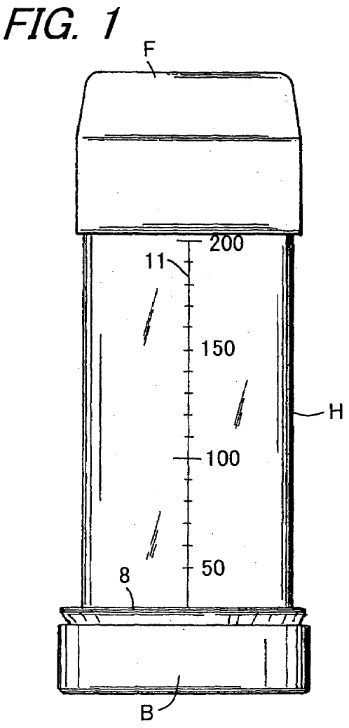

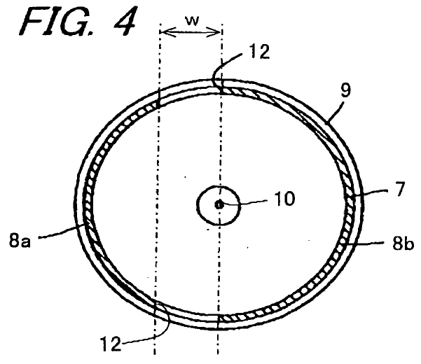

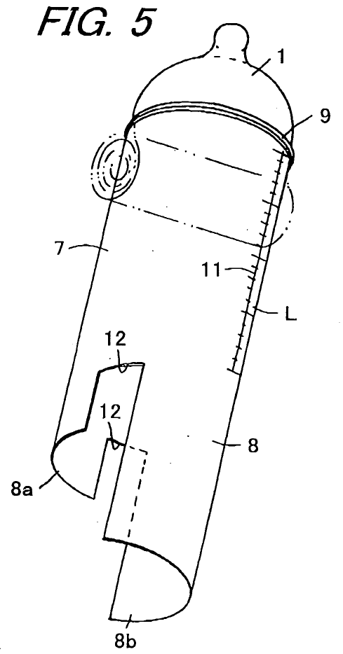

The invention is described in detail on its specific constitutions with reference to the accompanying drawings. FIG. 1 to FIG. 9 show a disposable nursing bottle according to a first embodiment of the invention, which has four components: a liner holder (H); a removable bottom cap (B); a liquid (e.g. milk) carrying liner (L) made integral with a nipple (1); and a top hood (F) for protecting the nipple.

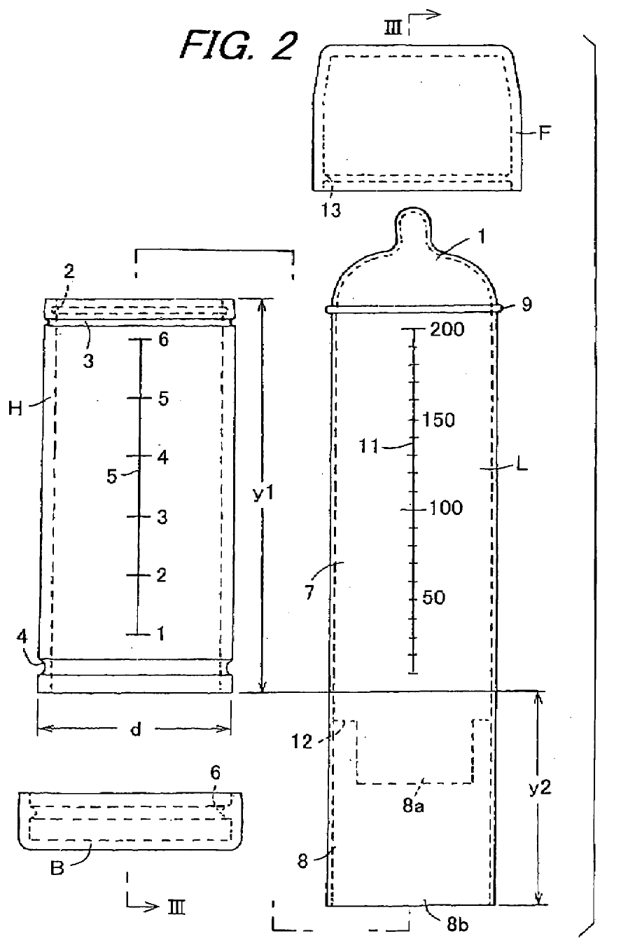

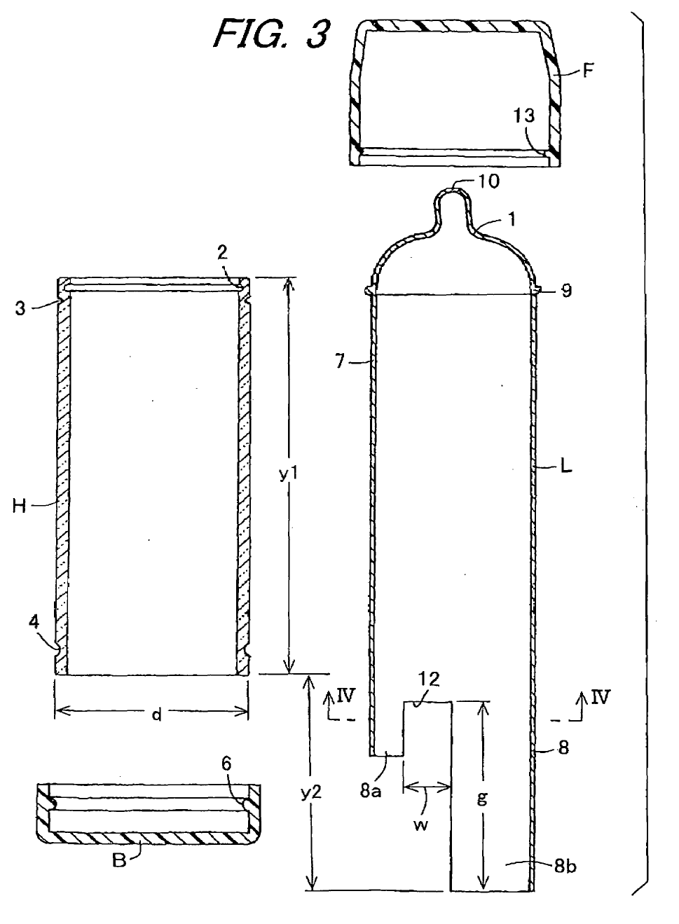

Of the components thus enumerated, the liner holder (H) is molded of a transparent or semitransparent hard synthetic resin such as polypropylene or polyethylene terephthalate, into a cylindrical shape having a predetermined diameter (d) (e.g., about 60 mm) and a predetermined length (yl) (e.g., about 140 mm), as shown in FIG. 2 and FIG. 3.

Reference numeral (2) denotes a nipple receiving groove formed in the upper end portion of the inner circumference of the holder (H). The nipple receiving groove (2) receives and holds the root portion of the nipple (1) bulging out continuously from the liquid carrying liner (L). Reference numeral (3) denotes a top hood fitting groove, which is recessed near the upper end portion of the inner circumference of the holder (H) Reference numeral (4) denotes a bottom cap fitting groove, which is also recessed near the lower end portion of the outer circumference.

Here, this holder (H) is preferably equipped on its outer circumference with an indicating graduation (5) for indicating the content of liquid or irregularities (not-shown) for preventing the slippage when gripped.

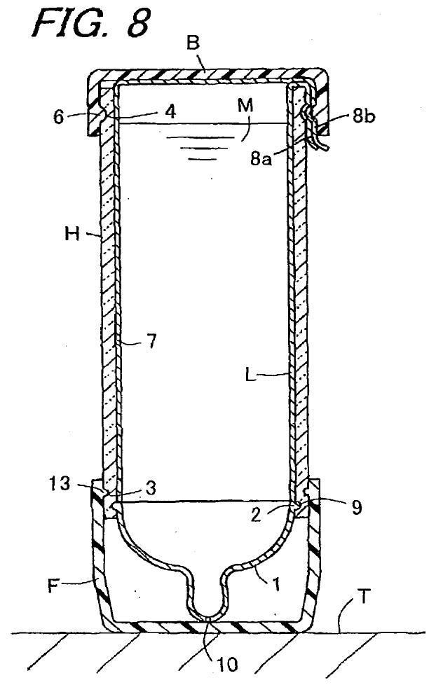

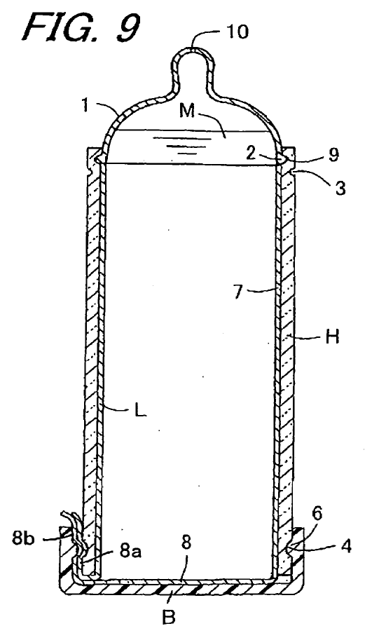

Moreover, the removable bottom cap (B) of the holder (H) is molded of a colored hard synthetic resin like that of the holder (H), into a substantially U-shaped section, as shown in FIG. 3, FIG. 8 and FIG. 9. This bottom cap (B) is enabled to cover the opening at the lower end of the holder (H) by removably inserting and fitting its fitting ridge (6) extending in a complementary manner from the vicinity of the upper end portion of the inner circumference, removably in the bottom cap fitting groove (4) on the side of the holder (H).

However, these fitting male-female relations may be reversed such that the fitting groove (4) is formed in the inner circumference of the bottom cap (B) whereas the ridge (6) is formed in the outer circumference of the holder (H) so as to be complementary to the fitting groove (4). It is also desired that irregularities (not shown) for preventing the slippage when gripped are formed on the outer circumference of this bottom cap (B).

Next, the liquid carrying liner (L) is formed of a transparent or semitransparent soft synthetic resin of polyethylene or the like which is hard to break, into such a thin tube shape as is radially smaller but longer than the holder (H) as shown in FIG. 2 to FIG. 5. The liner body (7) is closed at its upper end portion as the nipple (1) bulging continuously upward but is opened at its lower end portion as a folding skirt (8).

This liner (L) can be formed into a flexible tube shape either by extrusion-molding the aforementioned soft polyethylene or another synthetic resin or by jointing or sealing a plurality of films or sheets of that synthetic resin.

On the other hand, the nipple (1) is molded of an inactive/non-toxic soft material such as silicone rubber or thermoplastic resin elastomer, into a portion to be bitten by a baby. The nipple (1) is integrally jointed at its root portion to the upper end portion of the liner body (7) by fixing means such as an adhesive or a heat seal (or welding).

Reference numeral (9) denotes a radially large bead or flange for positioning which bulges out from the integrally jointed root portion. This bead or flange (9) is fitted in the nipple receiving groove (2) on the side of the holder (H). Reference numeral (10) denotes a liquid sucking hole opened in the central portion of the leading end of the nipple (1). Reference numeral (11) denotes a graduation, which is formed on the outer circumference of the liner body (7) of the liner (L) thereby to indicate the contents of the liquid, which can be prospectively viewed through the holder (H).

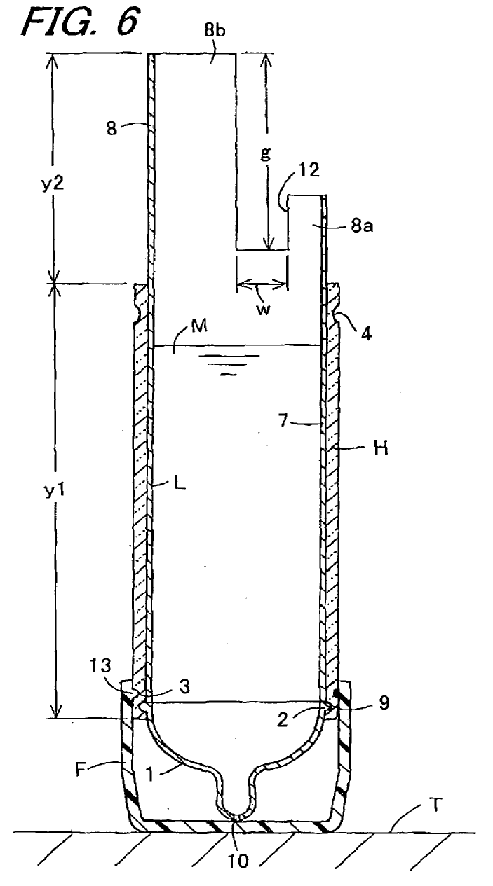

The liner (L) crowned with the nipple (1) as an accessory can be removably inserted either upward or downward into the cylindrical holder (H). In the set state where the aforementioned bead or flange (9) is fitted and retained in the nipple receiving groove (2) at the holder (H) side, the nipple (1) closing the upper end portion of the liner body (7) bulges out by itself from the upper end of the holder (H), as shown in FIG. 6 and FIG. 9. On the other hand, the folding skirt (8) opening the lower end portion of the liner body (7) hangs out by a predetermined length (y2) from the lower end portion of that holder (H).

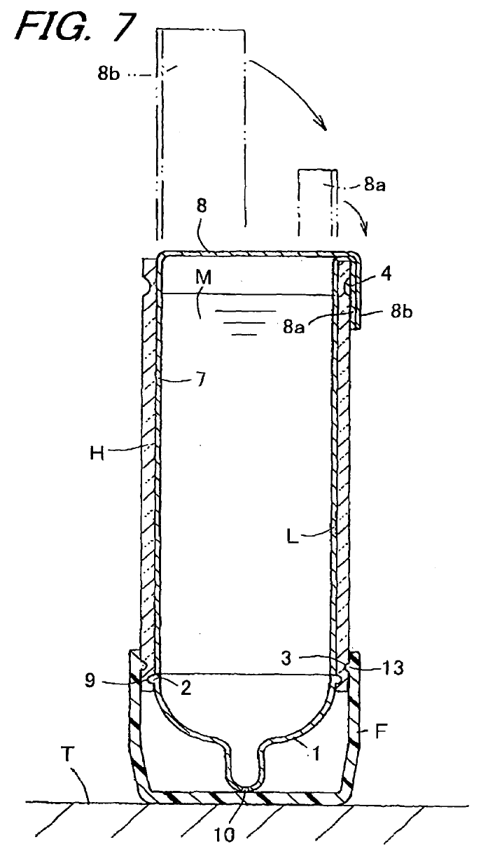

Here, a certain length (y2) of the folding skirt (8) of the liner (L) hanging out from the lower end portion of the holder (H) is set to a size larger than the diameter (d) of the holder (H) Specifically, the length is set such that the folding skirt (8) extends (by about 80 to 90 mm, for example), when folded as shown in FIG. 7, so as to get over the opening at the lower end of the holder (H) and reach a height position of the bottom cap fitting groove (4), and such that its leading edge is stably clamped and fixed on the outer circumference of the holder (H) by the bottom cap (B).

Thus, the nursing bottle can be held in such a sealed state that a liquid (M) will not accidentally leak out even when the nursing bottle falls down sideways.

Depending upon the thickness and the flexibility of the tubular liner (L) itself, however, the liner (L) has its overlapped portions increased uselessly, when folded at a right angle from the lower end portion of the cylindrical holder (H), and excessively wrinkled, in a case where the extending lower end portion of the skirt (8) is just cut straight. As a result, the adhesion of the bottom cap (B) to the outer circumference of the holder (H) may be so lowered as to allow the liquid (M) to leak out.

In order to prevent this, as shown in FIG. 3 to FIG. 6, it is preferred to cut off a slit (12), which has a predetermined depth (g) extending from the bottom of the skirt (8) but not reaching the lower end portion (or the folding line) of the holder (H) and a proper width (w) offset to the entrance corner, thereby to reduce the thickness of the folded overlapped portions at that skirt (8).

Moreover, it is the most preferably effective to divide the folding skirt (8) through the slit (12) opened upward into a shorter skirt member (8a) on the entrance corner side and a longer skirt member (8b) on the exit corner side. This is because the folded lead end portions of the skirt (8) are uniformly arranged to enhance the decorative effect, in addition to the aforementioned preventing effect.

The nipple protecting top hood (F), although having been shortly described, is molded of a transparent or semitransparent hard synthetic resin of the same kind as that of the aforementioned holder (H), into a generally inverted U-shape, as shown in FIG. 2 and FIG. 3. From the lower end portion of the inner circumference of the top hood (F), there bulges out a ridge (13), which is fitted in the top hood fitting groove (3) on the side of the holder (H).

When the ridge (13) on the top hood (F) is removably fitted in the top hood fitting groove (3) of the holder (H), therefore, the nipple (1) of the liner (L), which has been positioned and regained in advance on the side of the holder (H), can be safely covered downward so that the nipple (1) can be held in a sanitary state.

In this case, too, the male-female relations can be reversed to form the fitting groove (3) in the inner circumference of the top hood (F) and the fitting ridge (13) on the outer circumference of the holder (H) side, respectively, in the complementary manner. It is also desired that irregularities (not shown) for preventing the slippage when gripped are formed on the outer circumference of the top hood (F) It is also conceivable to apply a color identical to or different from that of the bottom cap (B) to the top hood (F).

The disposable nursing bottle of the invention is assembled with the constitution thus far described. When this nursing bottle is to be used, the bottom cap (B) is removed at first from the holder (H), as shown in FIG. 6. The holder (H) is vertically inverted and gripped in the inverted position, or the nipple protecting top hood (F) is stably grounded on a table (T). The liquid (M) prepared is poured down into the liner (L). Alternatively, powder milk and hot water can also be prepared in that liner (L). The liner (L) has contents of the liquid (M) of about 100 to 250 milliliters, for example.

Thus, the tubular liner (L), which is radially smaller at first than the holder (H), is held in such an expanded state by its flexibility as conformably fits on the inner circumference of the holder (H). As a result, the folding skirt (8), as extended from that holder (H), of the liner (L) is then folded at a right angle, as shown in FIG. 7, to cover the bottom cap fitting groove (4) of the holder (H) on the outer circumference.

At last, the bottom cap (B) is fitted downward, as shown in FIG. 8, on the bottom cap fitting groove (4) of the holder (H) thereby to clamp and fix the folding skirt (8) of the liner (L) between the bottom cap (B) on the outer side and the holder (H) on the inner side.

Thus, the nursing bottle is held in such a sealed state that the liquid (M) contained in the liner (L) will not leak out in the least even when the nursing bottle is returned to the upright state, as shown in FIG. 9, or fallen down sideways. When the top hood (F) is removed, therefore, the exposed nipple (1) can nurse the baby with the liquid (M).

After the use, the bottom cap (B) is removed from the holder (H), and the liner (L) and the accompanying nipple (1) may be extracted and discarded altogether. Especially, the liner (L) and the nipple (1), which contact with or are wetted with the liquid (M), can be discarded so that the nursing bottle can be carried remarkably conveniently on vehicles or for travels.

The holder (H), the bottom cap (B) and the top hood (F), as left undiscarded, do not make direct contact with the liquid (M), so that they need not be washed and/or sterilized but can be repeatedly used as they are. The top hood (F) is a molded article of a hard synthetic resin even when wetted with the liquid (M), so that the top hood (F) can be easily washed anywhere in travel.

In a case where the nursing bottle is reused, the liner (L) having a new nipple (1) attached thereto may be inserted into the holder (H), and the positioning bead or flange (9) bulging out from the root portion of the nipple (1) may be fitted and retained in the nipple receiving groove (2) on the side of the holder (H). In this set state, the aforementioned operations may be performed in accordance with the sequences of FIG. 6 to FIG. 8.

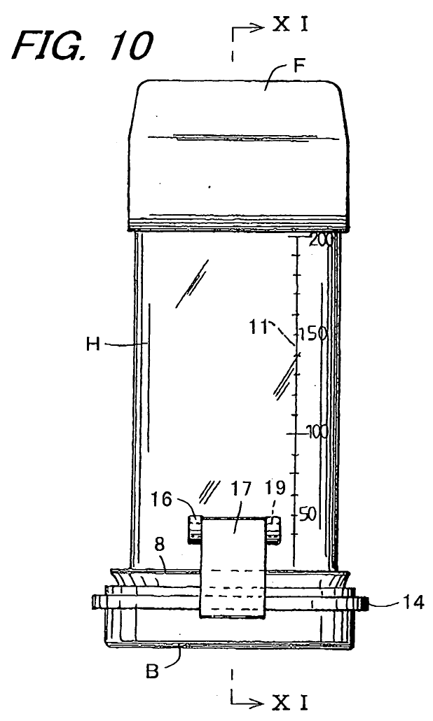

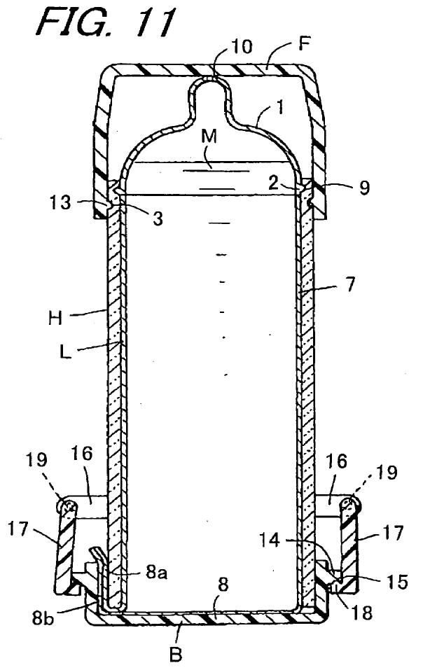

In the first embodiment of FIG. 1 to FIG. 9, the folded and overlapped portion of the liner (L) is bitten and sealed such that the ridge (6) of the openable bottom cap (B) side is fitted in the groove (4) of the holder (H). However, this constitution may be replaced by another of a second embodiment of FIG. 10 and FIG. 11, in which the bottom cap (B) for covering the holder (H) is pulled and press-fitted on the lower end portion of the holder (H).

Specifically, retaining grooves (15) opened downward are formed in a radially large ring-shaped flange (14) integrally bulging out from the outer circumference of the bottom cap (B). Pulling hooks (17) are turnably hinged to a pair of support arms (16) integrally extending from intermediate height positions of the outer circumference of the holder (H). Retaining ridges (18) rising upward from the leading end portions (or the lower end portions) of the individual pulling hooks (17) are removably retained in the so-called lever actions in the retaining grooves (15) opened in the flange (14) of the bottom cap (B), so that the bottom cap (B) is held in the state in which the bottom cap (B) is pulled and forced on the lower end portion of the holder (H).

Thus, the liner (L) is clamped and fixed between the lower end portion of the holder (H) and the bottom cap (B) so that the liquid (M) will not accidentally leak out. The liner (L) has the flexibility so that the liner (L) is sealed in the so-called bound state.

Here, the male-female relations between the retaining ridges (18) and the retaining grooves (15) can also be so reversed that the ring-shaped flange (14) bulges out from the side of the holder (H) and that the pulling hooks (17) and their support arms (16) are disposed on the side of the bottom cap (B). Reference numeral (19) denotes the turning fulcrums of the pulling hooks (17).

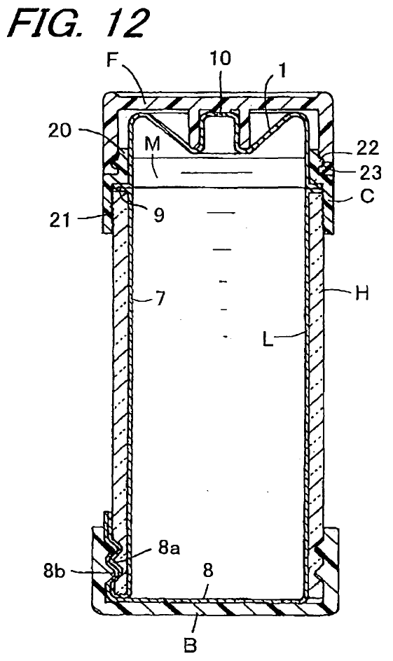

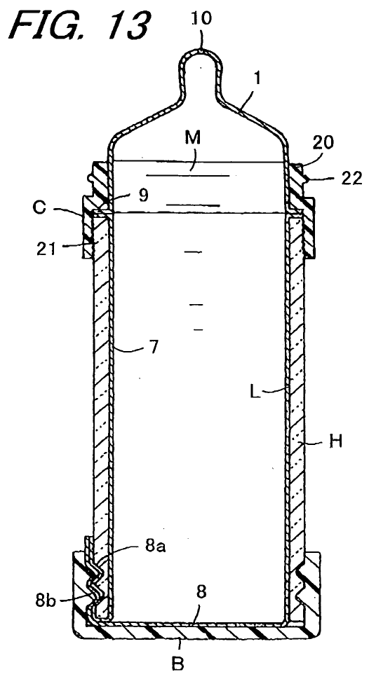

FIG. 12 and FIG. 13 show a third embodiment of the invention. The disposable nursing bottle is composed of totally five parts: the holder (H); the bottom cap (B); the liner (L) having the nipple (1) formed integrally therewith; the top hood (F); and a nipple holding collar (C).

Specifically, the nipple holding collar (C) forming the component of the third embodiment is molded into a stepped cylinder shape made of the same colored hard synthetic resin as that of the bottom cap (B) and including a top hood receiving mouth cylinder (20) forming a radially smaller upper half and a radially larger threaded mouth cylinder (21) forming the remaining lower half. A top hood fitting ridge (22) extends integrally from the outer circumference of the top hood receiving mouth cylinder (20).

In the third embodiment, moreover, the radially enlarged and positioning bead or flange (9), which bulges out from the root portion of the nipple (1) made integral with the liner (L), is positioned and retained on the upper end portion of the holder (H). When the threaded mouth cylinder (21) of the nipple holding color (C) is removably fastened on the outer circumference of the holder (H), the bead or flange (9) is pushed and fixed downward by the nipple holding collar (C).

As a result, the liner (L) with the nipple (1) can be conveniently inserted downward into the holder (H). The liner (L) can also be lightly extracted, when discarded, upward from the holder (H) so that the liner handling can be improved.

Reference numeral (23) denotes a fitting groove which is so formed in the inner circumference of the top hood (F) as is positioned to correspond to the ridge (22) of the top hood receiving mouth cylinder (20) in the nipple holding collar (C). The nipple (1) of the liner (L), which is held and fixed in advance on the side of the holder (H), can be safely covered with the top hood (F) by fitting the groove (23) of the top hood (F) side removably on the ridge (22) of the nipple holding collar (C) side.

Moreover, a nipple depressing cylinder (24) hangs out integrally from the central portion of the top hood (F) having a generally inverted U-shape. When the top hood (F) is fitted on the receiving mouth cylinder (20) on the nipple holding collar (C) side, the nipple depressing cylinder (24) deforms the nipple (1) elastically to sink by itself.

As a result, in a case where the length (yl) of the aforementioned holder (H) is assumed to be constant, the nursing bottle can be made so low and small by an amount with which the nipple (1) is depressed to sink. Here, the male-female relations between the fitting groove (23) in the top hood (F) side and the ridge (22) on the nipple holding collar (C) can also be reversely set.

In the case of the third embodiment, moreover, the openable bottom cap (B) is removably fastened on the outer circumference of the holder (H) This threaded fastening means can be adopted because the liner (L) is made so thin and soft that the liner (L) can be freely elastically deformed. The folding skirt (8) of the liner (L) can be clamped and fixed in a biting sealing state between the outer circumference of the holder (H) and the bottom cap (B).

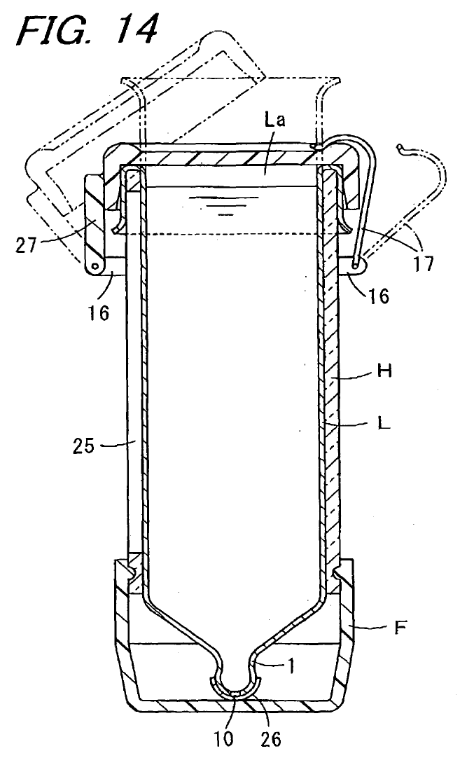

Subsequently, as shown in FIG. 14, in a forth embodiment of the invention, the liner holder (H) is formed of a metal such as aluminum or stainless steel, and a slit (25) is formed over a substantially entire length of the liner holder (H), that is, over the liner holder (H) except both ends in an axial direction thereof. Through the slit (25), it is possible to look inside of the liquid carrying liner (L).

Further, the liquid carrying liner (L) and the nipple (1) are formed into a single body by use of silicone rubber as a common material.

Furthermore, to the sucking hole (10) of the nipple (1) is adhered a peeling seal (26). The peeling seal (26) prevents the liquid from leaking when the liquid is poured into the liquid carrying liner (L) which is put so that a lower-end opening (La) thereof is upward. The peeling seal (26) is supported by the top hood (F) and therefore, the peeling seal (26) does not need very strong adhesiveness, and a temporarily attached level is a sufficient level of adhesive strength between the liquid carrying liner (L) and the peeling seal (26). Accordingly, when selecting an adhesive agent, a priority is given to harmlessness of the agent. Thus, a starch glue is used, for example. As a consequence, the peeling seal (26) can be peeled off easily on feeding.

Moreover, as to the liquid carrying liner (L), the skirt (8) is made straight. The skirt (8) of the liquid carrying liner (L) is folded back toward outside of the liner holder (H), and the bottom cap (B) is fitted on the liner holder (H). The pulling hook (17) is formed of a metal wire. In a state where the bottom cap (B) is fitted on the liner holder (H) by way of the liquid carrying liner (L), the bottom cap (B) is biased toward the liner holder (H) by a spring force. That is to say, the pulling hook (17) is used to apply the spring force to the bottom cap (B) so that the bottom cap (B) is resiliently fitted on the liner holder (H).

In this case, the liner holder (H) is provided with the pair of support arms (16) integrally extending from intermediate height positions of the outer circumference of the holder (H). One support arm (16) may be provided with the hook (17) whereas the other support arm (16) may be provided with a hinge (27) which is formed integrally with the bottom cap (B).

Here, the remaining constitutions and usages in the second and third embodiments are substantially identical to those of the foregoing first embodiment. Therefore, their detailed descriptions are omitted by inserting the reference numerals corresponding to those of FIG. 1 to FIG. 9 into FIG. 10 to FIG. 13.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A disposable nursing bottle comprising:
a liner holder formed into a cylindrical shape, having openings at upper and lower ends thereof, the liner holder being made hard and an inside thereof being visible;
a liquid carrying liner formed into a tube longer and thinner than the holder, the liquid carrying liner being removably inserted into the holder;
a nipple integrally connected to the liner;
a nipple protecting top hood removably covering the opening at the upper end of the holder; and
a bottom cap removably covering the opening at the lower end of the holder,
wherein desired liquid is poured from the opening at the lower end of the liquid carrying liner in a state where the top hood is put downward so that the opening at the lower end of the liquid carrying liner is directed upward, and a protruded portion of the liquid carrying liner which protrudes from the liner holder is folded and then the bottom cap is pressed and fitted on the folded protruded portion to seal the opening so that the liquid to be contained is encapsulated in the liner.

2. The disposable nursing bottle of claim 1, wherein the nipple is formed integrally with the liquid carrying liner by use of silicone rubber as a common material.

3. The disposable nursing bottle of claim 1, wherein the liner holder is formed of a light transmitting synthetic resin.

4. The disposable nursing bottle of claim 1, wherein the line holder is formed of a metal, and over a substantially entire length of the liner holder is provided a slit through which an inside of the liquid carrying liner is visible.

5. The disposable nursing bottle of claim 1, wherein the protruded portion of the liquid carrying liner hanging out by a predetermined length from a lower end portion of the holder is divided into a shorter skirt member on an entrance corner side and a longer skirt member on an exit corner side by a slit which has a predetermined depth not reaching the lower end portion of the holder cut off upward and an appropriate opening width.

6. The disposable nursing bottle of claim 1, wherein a radially large bead or flange for positioning bulges out from a root portion of the nipple, and
the bead or flange is placed and retained on an upper end portion of the holder, or fitted and retained in a nipple receiving groove which is formed in an upper end portion of an inner circumference in the holder so as to be complementary to the bead or flange.

7. The disposable nursing bottle of claim 1, wherein a radially large bead or flange for positioning, which bulges out integrally from a root portion of the nipple is placed and retained on an upper end portion of the holder,
a radially large threaded mouth cylinder of an appropriately lower half portion in a nipple holding collar formed of a hard synthetic resin into a stepped cylinder is removably fastened threadably on an outer circumference of the holder so that the bead or flange of the nipple is pushed and fixed downward, and
the nipple protecting top hood is removably fitted over a radially smaller top hood receiving cylinder of an appropriately upper half portion in the nipple holding collar.

8. The disposable nursing bottle of claim 1, wherein the liner holder is formed of a metal wire and provided with a pulling hook for biasing the bottom cap toward the liner holder by use of spring force in a state where the bottom cap is fitted on the liner holder by way of the liquid carrying liner.

9. The disposable nursing bottle of claim 1, wherein the nipple is provided with a liquid sucking hole to which a peeling seal is adhered.
